(19) United States
(12) Patent Application Publication
(10) Pub. No.: US 2007/0163127 A1
(43) Pub. Date: Jul. 19, 2007

(54) Drive handle and power poker for carving soft materials

(76) Inventors: Justin Discoe, Windsor, CO (US); Kurt Van Ulmer, Denver, CO (US); Tyler Smith Cornaby, Gastonia, NC (US); Cheryl Stoughton Goff, Denver, CO (US)

Correspondence Address: MARTIN & HENSON, P.C., 9250 W 5TH AVENUE, SUITE 200, LAKEWOOD, CO, 80226, US

(21) Appl. No.: 11/529,775

(22) Filed: Sep. 27, 2006

Related U.S. Application Data
(63) Continuation-in-part of application No. 11/236,473, filed on Sep. 27, 2005.
(60) Provisional application No. 60/721,043, filed on Sep. 27, 2005.

(51) Int. Cl. B26B 15/00

(52) U.S. Cl. 30/277.4

(57) ABSTRACT

A power drive handle for a handheld tool includes a case with an opening in its nose. A drive motor and a carriage are disposed in the case interior. A drive train located in the interior interconnects the carriage to the motor so that the motor reciprocates the carriage. The carriage is adapted to releasably mount the tool handle so that the tool element thereof projects through the nose opening. A wing extension projects longitudinally forwardly of the nose adjacent to the tool opening. A detachable access panel allows the user to insert and remove the handheld tool. The case can have a compartment to receive batteries for powering the motor. The carriage may be trough-shaped and can be slideably mounted in a longitudinal slideway secured in the casing. The tool element may, for example, be a poker or a saw.

### FIELD OF THE INVENTION

The present invention generally relates to tools that may be used to cut relatively soft materials. More particularly, the exemplary embodiments of the present invention are directed to pokers that may be used to transfer decorative patterns onto soft surfaces such as the shells of pumpkins, watermelons, squash, gourds and the like and to saws that may be used to carve decorative features into soft shell materials.

### BACKGROUND OF THE INVENTION

A wide variety of tools have heretofore been known and used to transfer art onto soft materials such as the fleshy shells of fruits which include, for example, pumpkins, watermelons, squash, gourds, etc. Art includes, but is not limited to, decorative features, especially to celebrate festivities such as Halloween, Thanksgiving and even the Fourth of July. Traditionally, the art is transferred by manually thrusting a pointed object into the soft material to create a series of marks that can be sequentially followed with a cutting tool to remove portions of the material to create said decorative features. After transfer of the pattern art, the user then carves the shell with the decorative features.

In addition, a wide variety of cutting tools have long been known, and many such cutting tools are mechanically driven, for example, by electric motors. On one hand, these power tools may have a power cord that may be plugged into an electrical outlet. On the other hand, it is known that these power tools may be battery operated, as well. Many such power tools are robust so as to handle heavy duty cutting jobs. Such tools include a variety of power saws, drills, and the like.

Naturally, traditional power tools are not usually the type that may be used to cut soft materials such as the fleshy shells of fruits which include, for example, pumpkins, watermelons, squash, gourds, etc. Often, people desire to carve such fruits with decorative features, especially to celebrate festifications such as Halloween, Thanksgiving and even the Fourth of July. Traditionally, the carving of features into these fruits has been accomplished by employing manually operated tools.

For a long time, such carving was done with pocket knives, paring knives and the like. Due to the size of these cutting instruments, a typical carver was only able to obtain limited, fairly large-scale decorative features. In more recent years, however, new techniques and tools were developed to carve more elaborate and decorative features into the shell of the fruit, especially pumpkins. These techniques were spurred by the introduction of the pumpkin carving kit which was developed and described in U.S. Pat. No. 4,828,114 issued May 9, 1989 to Bardeen. This kit included manually operated drills and saws having fine-toothed, small-dimensioned blades that could be used for more detailed cutting. An example of such a saw may be found the '114 Patent, with a more detailed example of such a saw being taught in U.S. Pat. No. 4,841,638 issued Jun. 27, 1989 to Bardeen et al.

Where a person seeks to carve a large number of fruits or carve very large and elaborate designs in the fruits, the use of hand operated saws can be tiresome and in some instances, somewhat frustrating. For example, as the user provides a vertical reciprocating motion, to create the sawing action, the user must also apply a forward motion in the cutting direction to move the blade against the material to be cut. Sometimes, this multiple action is difficult, and the user does not apply a uniform forward force or a uniform reciprocating force. This can frustrate the users ability to cut clean, even lines. Where intricate features are being carved such non-uniform force can create uneven cut lines and can even inadvertently tear the soft material that is being cut thereby ruining the carved design.

While the pumpkin carving kits exemplified by the '114 Patent have had wide commercial success and have greatly increased the enjoyment of the festive holiday for many people, these kits nonetheless have various associated drawbacks. One particular drawback is the way in which the patterns are transferred to the surface of the pumpkin. More specifically, the pumpkin carving kit instructs the pumpkin carver to poke small holes through the pattern sheets and into the surface of the pumpkin and recommends that these small holes be between 1/16″ to “⅛” apart to best transfer the pattern.

Accordingly, the pumpkin carving kit is associated with a poker tool that is capable of forming these small holes. However, other tools such as hatpins or pushpins are also adequate to transfer these pumpkin patterns. The poker tool, hatpin, and pushpin are similarly configured in that each has a structure that allows for one small puncture hole to be made in the pumpkin's surface at a time. Further, each tool must be completely removed from the pumpkin surface in order to form an adjacent puncture hole. Since a pattern is best transferred if the puncture holes are between 1/16″ to ⅛″ apart, even a simple pattern may require a large number of puncture holes to properly transfer the design. More intricate designs, on the other hand, may require an extraordinary number of puncture holes. Since the poker tool, hatpins, and pushpins can only form one puncture hole at a time, the repeated process of poking through the pattern and into the pumpkin, and then removing the tool before forming another hole, is slow and tedious.

Furthermore, attempts to shortcut this process by forming holes that are too far apart oftentimes make the transferred pattern too difficult to carve properly. Therefore, although the pumpkin carving kit described in the '114 Patent revolutionized pumpkin carving, there remains a need for an improved tool and method of transferring a pattern into the pumpkin shell that is faster and less tedious than using a poker tool, hatpin, or pushpin. The present invention is directed to meeting those needs.

### OBJECTS OF THE INVENTION

It is an object of the invention to provide a new and useful powered handheld tool that may be used for creating puncture marks in a soft material, such as a pumpkin shell, gourd, watermelon, fruit, etc.

It is another object of the invention to create a handheld poker tool to use in conjunction with a previously conceived drive handle and power saw for carving soft materials.

It is an aspect of at least one exemplary embodiment to create a stabilizing feature to limit the amount of kickback from making contact with the soft material.

It is another aspect of at least one exemplary embodiment to provide a structure allowing a user to manually adjust the amount of penetration the poking tool into the soft material.

Another aspect of at least one exemplary embodiment is to reduce fatigue, and time spent transferring designs to the target material, as well as increase precision of poking tool.

The exemplary embodiments of the present invention disclose a power drive handle for a hand held tool that is adapted for use in carving soft materials. This power drive handle is configured to removably receive a hand held tool such as a hand held saw or a hand hold poker wherein the tool includes a tool handle and a tool element. In addition, the present disclosure illustrates a specially configured power poker for use with such a power drive handle.

Accordingly, the power drive handle depicted herein includes a case having a forward nose with a tool element opening formed therein. A drive motor is disposed in the interior of the case, and a carriage is also disposed in the interior. This carriage is mounted for reciprocal motion in a longitudinal direction, and it is adapted to releasably mount the tool handle of a hand hold tool such that the tool element thereof protrudes from the case through the tool element opening when in the mounted state. A drive train is disposed in the interior of the case, and the drive train couples the drive motor and the carriage such that operation of the drive motor acts to reciprocate the carriage whereby the tool element is reciprocated when in the mounted state. A wing extension projects longitudinally forward of the nose of the case adjacent to the tool element opening.

In the disclosed embodiments, the case includes at least one such access panel that is attachable so as to allow access to the carriage whereby the tool handle of a selected hand held tool may be mounted and demounted therein. Two such access panels are described, one of which is particularly adapted for use with a hand held saw and the other of which is particularly adapted for use with the hand held poker. Where a hand held poker is contemplated, the wing extension is provided as a guide for transferring a pattern onto the soft surface. Here, the wing extension may be formed on the access panel. The wing extension has a longitudinally extending linear first edge located adjacent to the tool element opening and an arcuate second edge so as to define a forwardly located rounded profile. Moreover, if desired, the access panel(s) may be transparent.

The case includes a compartment adapted to receive a power supply, such as batteries, for the drive motor. The casing can include a forwardly located nose wherein the tool element opening is formed in the nose.

The carriage that is disposed in the case may be trough shaped in configuration so as to provide a bay adapted to receive the tool handle. Where the tool handle includes a flange, the carriage may have a groove that is sized and adapted to receive the flange when the tool handle is received in the bay. A trough shaped guide member may be mounted in the casing to form a longitudinally extending slideway sized and adapted to slidably receive the carriage member therein for reciprocal movement.

The drive motor can include an output pinion gear. Here, the drive train may include a reduction gear mechanically coupled to the pinion gear and a gear crank mechanically coupled to the reduction gear. The carriage is then mechanically coupled to the gear crank.

The case may include an optional storage space that is adapted to receive a hand held tool. A spring clip can be provided to help retain this hand held tool in the storage space.

From the foregoing, it should be appreciated that at least one embodiment of the present invention provides a handheld power poker that is adapted for use in transferring patterns to be carved in soft materials. Here, the hand held power poker includes a power drive handle as described above. In addition, a poker tool is provided that includes a poker handle having a central longitudinal axis and a longitudinally and forwardly extending shaft terminating at a point. The tool handle is sized and adapted to be releasably mounted in the above-described carriage in a mounted state such that the shaft protrudes through the tool element opening. Here, also, the wing extension is desirable. The poker tool may be configured so that it may be mounted in only a single orientation relative to the carriage so that the shaft is oriented in the common plane with the wing extension. To this end, the shaft may be laterally offset from the central longitudinal axis of the poker handle, and the flange of the hand held poker may include positioning structures, such as posts, so that the flange may be mounted in the carriage groove in only a single orientation.

Finally, it should be appreciated that the exemplary embodiments contemplate a power drive handle that may be used in combination with both a hand held saw and a hand held poker, all as described above. Here, however, the power drive handle includes a case that has two detachable access panels that may be selectively mounted thereto. One such access panel has the wing extension projecting longitudinally forward of the nose of the casing adjacent to the tool element opening so as to provide a guide for the shaft of a handheld poker. The other such access panel may omit the swing extension for use with a hand held saw. Accordingly, in this embodiment, a poker tool is provided for releasable mounting in the carriage. Likewise, a handheld saw is provided for releasable mounting in the carriage. An optional storage region is provided, so that, when one such tool is not in use, it may be stored within the handle yet readily accessible by the user.

These and other objects of the present invention will become more readily appreciated and understood from a consideration of the following detailed description of the exemplary embodiment of the present invention when taken together with the accompanying drawings, in which:

### BRIEF DESCRIPTION OF THE DRAWINGS

FIG. 1 is a perspective view of a power saw according to the exemplary embodiment of the present invention;

FIG. 2 is a perspective view of a prior art handheld saw of the type that is to be received by the drive handle of FIG. 1 according to the exemplary embodiment of the present invention;

FIG. 3 is a side view in elevation of a drive handle of the power saw of the present invention;

FIG. 4 is a top plan view of the drive handle of FIG. 3;

FIG. 5 is an end view in elevation of the drive handle of FIGS. 3 and 4;

FIG. 6 is a side view in elevation of the drive handle of FIGS. 3-5 with a section of the case removed therefrom to illustrate the internal components thereof;

FIG. 7 is an enlarged side view in elevation showing the distal end portion of the drive handle of FIG. 6 with the carriage member removed so as to reveal the gear drive and guide member therefore;

FIG. 8 is a perspective view of the gear drive and drive member of FIG. 7;

FIG. 9 is a perspective view of the carriage member that mounts in the guide member of FIGS. 7 and 8 for sliding, reciprocating movement;

FIG. 10 is a bottom plan view with the carriage member of FIG. 9;

FIG. 11 is a side view in elevation of the distal end portion of the drive handle illustrating the mounting of the handheld tool FIG. 2 in the carriage member of FIGS. 9 and 10;

FIG. 12 is a perspective view of the power poker according to the exemplary embodiment of the present invention;

FIG. 13 is a front elevation view of a power poker of FIG. 12;

FIG. 14 is a top plan view of the power poker of FIGS. 12 and 13;

FIG. 15 is a perspective view of the power guide;

FIG. 16 is a front elevation view of the power guide;

FIG. 17 is a cross section 17-17 view of the power guide, as referenced in FIG. 16;

FIG. 18A is a front view of the power guide, power poker and power saw base with the poker in the retracted position; and

FIG. 18B is a front view of the power guide, power poker and power saw base with the poker in the extended position.

### DETAILED DESCRIPTION OF THE EXEMPLARY EMBODIMENTS

The present invention generally concerns the carving of soft materials. The present invention is particularly directed to carving decorative items into the soft, fleshy shells of fruits such as pumpkins, squashes, watermelons, gourds and the like. However, it should be understood that the present invention may be used for carving or cutting other soft materials. One aspect of the present invention is the provision of a handheld poker that can be driven by a power operated drive handle in order to transfer a decorative pattern onto the shell for subsequent carving. To this end, a poker may be removably mounted in the drive handle. After transfer of the pattern, the poker may be removed and a handheld-type saw mounted for carving the pattern's features.

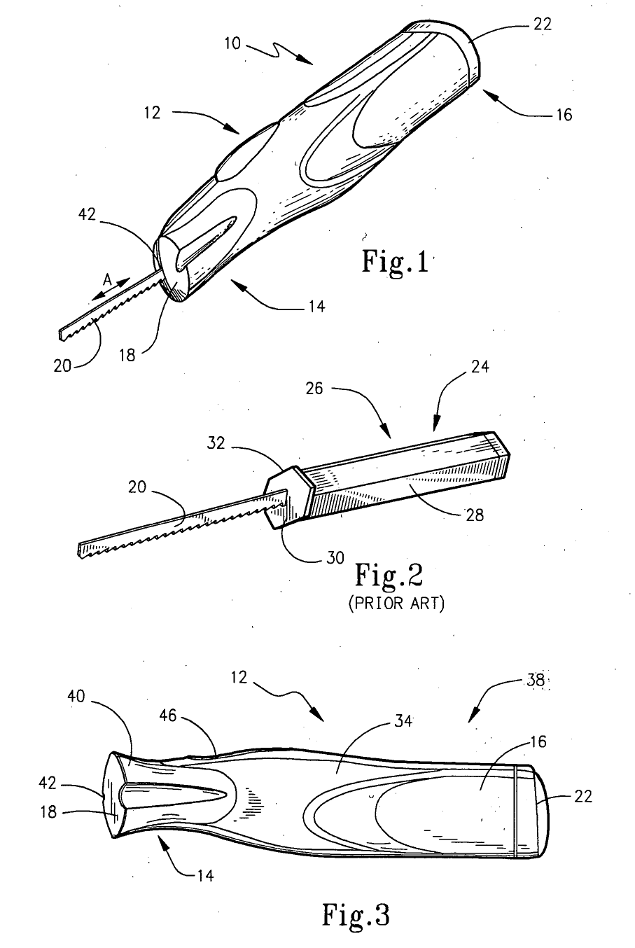

Accordingly, a power saw 10 according to the exemplary embodiment of the present invention is introduced in FIG. 1. Power saw 10 includes a drive handle 12 having a forward end portion 14 and a rearward end portion 16. Forward end portion 14 terminates in a nose 18 having an opening 42 through which a saw blade 20 extends in a longitudinal direction with saw blade 20 being driven reciprocally in the direction of arrow “A” by drive handle 12 as described more thoroughly below. An end cap 22 covers rearward end portion 16 and is provided to allow access to a battery compartment enabling the user to replace the power source in the form of batteries received therein.

Drive handle 12 is adapted to mount a handheld saw that is of the type known in the art, or other tool, such as the power poker described below. A handheld-type saw 24 is illustrated in FIG. 2, and the handheld saw 24 includes an elongated saw handle 26 that mountably supports the longitudinally extending saw blade 20. Handle 26 includes a body portion 28 that is here illustrated to be hexagonal in cross-section. Handle 28 terminates in a forward flange 30 that is slightly larger in dimension so as to provide a rim 32 extending therearound. Handle 26 is normally grasped manually by a user so as to manually reciprocate saw blade 20 during the carving of soft materials, such as a pumpkin shell, for creating decorative images therein. Drive handle 12 is adapted to receive a tool, such as saw 24, in order to provide a power drive therefor. It should be understood that the present invention is contemplated for use with such handheld saws, although other tools, if configured to have a handle similar to handle 26 may be operated as well. As noted below, a modification of the carriage member could allow use of differently configured handheld tools.

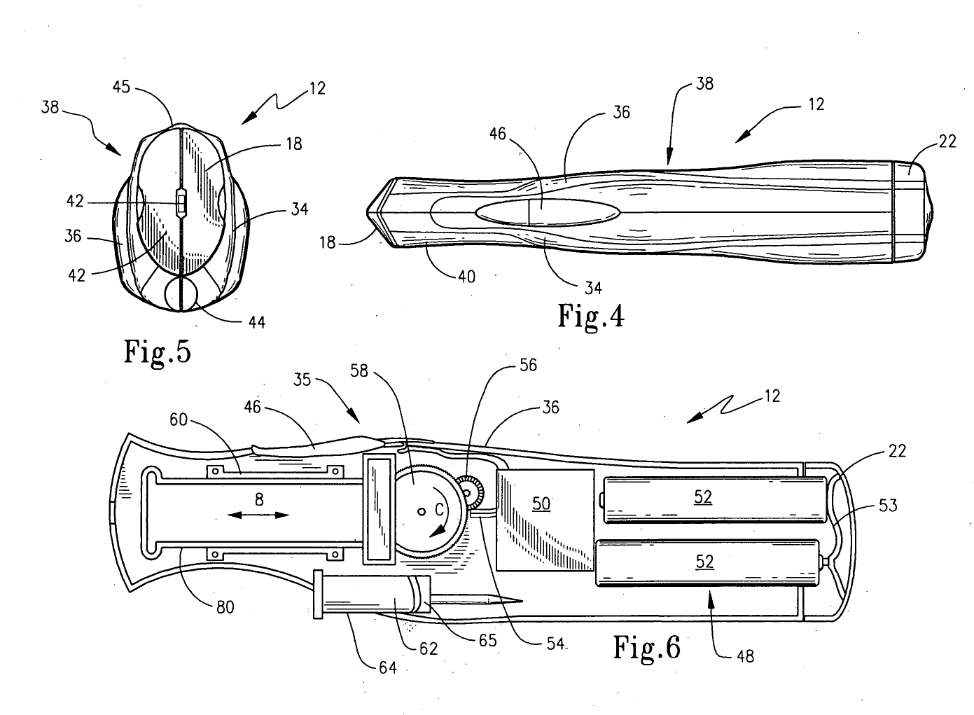

The external components of drive handle 12 are illustrated in FIGS. 3-5. Here, it may be seen that drive handle 12 is constructed as two mating sections 34 and 36 that form a case therefor. Handle sections 34 and 36 may be snap fit together or otherwise secured in any convenient manner known in the art. Preferably, handle sections 34 and 36 are formed of injection molded plastic or other suitable material. As noted above, end cap 22 is removeably mounted on the rearward portion 16 of drive handle 12 to allow access to the battery compartment. A forward end portion 14 of drive handle 12 is provided with a transparent access panel 40 that is removable to allow access to the interior of case 38 thereby to allow mounting and demounting of handheld saw 24 therein.

Moreover, as is illustrated best in FIG. 5, nose 18 has the rectangular opening 42 to accommodate saw blade 20 for unrestricted longitudinal reciprocal movement. Also, with reference to FIG. 5, an optional opening 44, shown in phantom, may be provided to allow storage of a poker tool such as those known in the art or as described herein, and as illustrated in FIG. 6. A spring clip 65 may be provided to retain such tool in opening 44. A switch button 46 is also supported by case 38 so that the user, by depressing switch button 46 may activate the drive handle for powered reciprocation of saw blade 20 and which, upon release, acts to shut the drive handle into an off condition.

The internal components of drive handle 12 are illustrated in FIG. 6 wherein drive handle 12 is depicted with handle section 34 and access panel 40 removed therefrom. In this illustration, end cap 22 is shown in cross-section. Here, it may be seen that case 38 supports a centrally located battery operated drive motor 50, which is powered by batteries 52 received in battery compartment 48. A number of batteries 52 and drive motor 50 selected to be compatible with one another, and it is expected that either three or four batteries 52 would be provided to power motor 50. End cap 22 includes a contact bridge 53 that both acts as a spring to mount batteries 52 as well as to establish electrical communication so that batteries 52 are electrically connected in series. Motor 50 has a pinon gear as an output drive gear 54, which turns a crown gear that is part of a reduction gear 56 that in turn drives a geared crank 58. Reduction gear 56 and geared crank 58 are mounted for supported rotational movement with respect to handle section 36. Other mechanical arrangements depending upon the drive motor and the desires speed of reciprocation could be made by the ordinarily skilled person in this field.

The forward end portion of drive handle 12 includes a guide member 60 that is mounted to handle section 36 and which slideably supports a carriage member 80 for reciprocal movement in the direction of arrow “B” when gear crank 58 is rotated in the direction of arrow “C”. As noted above, an optional opening is provided to receive a prior art poking tool, such as poking tool 62 illustrated in FIG. 6. To this end, spring clip 64 may also be provided to releasably retain poking tool 62 in a stored state. A user may withdraw poking tool 62 to create holes in the material to be carved so that saw blade 20 may be introduced into such holes. Alternatively, saw blade 20 may itself be used to poke through the material to start the cutting operation.

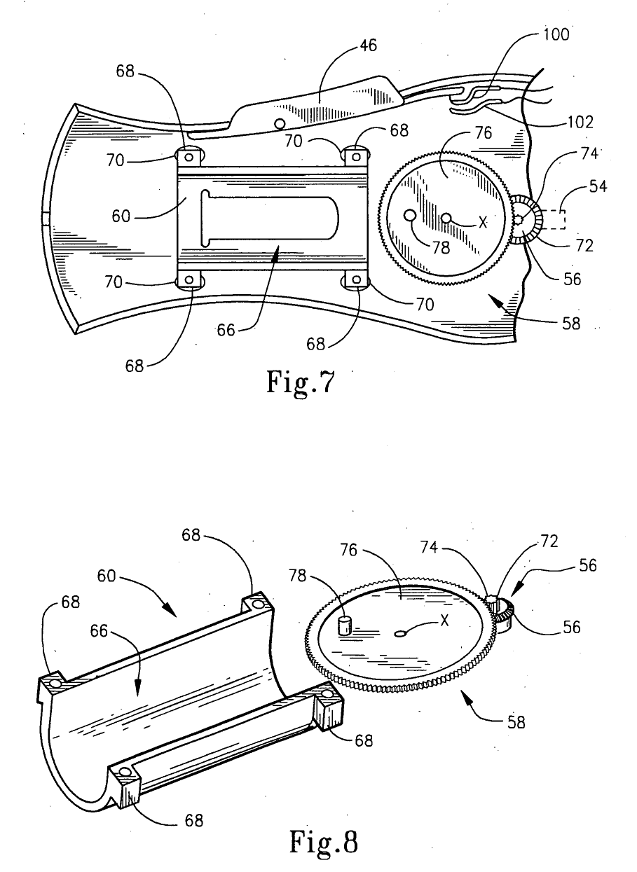

With reference now to FIGS. 7 and 8, the drive train and guide member 60 is illustrated in greater detail. In these figures, it may be seen that guide member 60 is trough-shaped in configuration so as to have a longitudinal extending slideway 66 therein. Guide member 60 includes a plurality of ears 68 that may be mounted on bosses 70 by any suitable means, such as screws and the like. Reduction gear 56 is driven by drive gear 54 (shown in phantom) and includes a first gear element 72 driven by drive gear 54 and a reduction gear element 74. Reduction gear element 74 engages the teeth of crank gear 76 that is provided with a crank pin 78. Together, crank gear 76 and crank pin 78 make up geared crank 58.

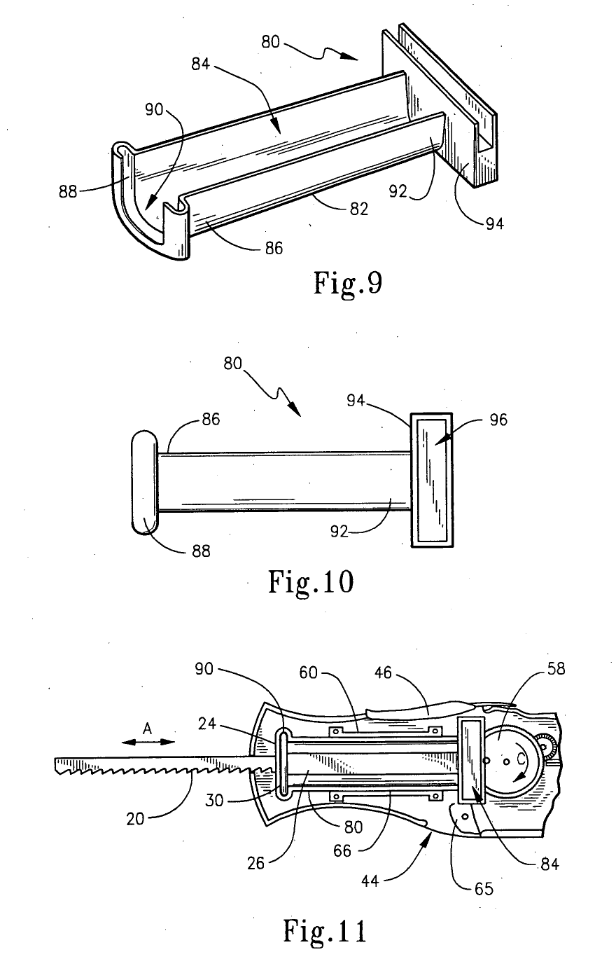

Geared crank 58 acts to reciprocate carriage member 80. To this end, carriage member 80 is best illustrated in FIGS. 9 and 10. With reference, then, to that figure, it may be seen that carriage member 80 includes a longitudinally extending body 82 that is sized and adapted for slidably supported, reciprocal movement in slideway 66 of guide member 60. Body 82 is therefore trough-shaped in configuration so as to have a longitudinally extending bay 84 that is sized and adapted to receive handle 26 of handheld saw 24. Forward end 86 of carriage member 80 terminates in a lip 88 that extends around the perimeter thereof and which is provided by an inwardly facing groove 90 that is sized and adapted to nestibly receive flange 30 of handle 26 of handheld saw 24. Rearward end 92 of carriage member 80 includes a cross-bar 94 that has a transverse slot 96 that is sized to mateably engage crank pin 78 of geared crank 58 when carriage member is mounted in slide way 66 of guide member 60. Accordingly, as crank pin 78 revolves around gear axis “X” shown in FIGS. 7 and 8, crank pin 78 will reciprocally drive carriage member 80 as it reciprocates in transverse slot 96. Reduction gear 56 and crank gear 76 are selected so as to increase torque and reduce speed from the drive gear 54 of motor 50.

The assembly of these components may be further appreciated with reference to FIG. 11. Here, it may be seen that handle 26 of handheld saw 24 is mounted in bay 84 of carriage 80. Flange 30 is received in groove 90 so that handheld saw 24 is secured for corresponding movement with carriage member 80. Carriage member 80 is slidably mounted in slideway 66 of guide member 60, and it should be understood that crank pin 78 resides in slot 96 of carriage member 80. Rotation of crank gear 58, thus acts to reciprocally drive carriage member 80 and thus reciprocate saw blade 20 in the direction of arrow “A”. This occurs, of course, when electrical connection is made between contacts 100 and 102, illustrated in FIGS. 7 and 11, which occurs upon depressing switch button 46.

While the carriage member 80 has been described herein with a configuration to nestably receive the handle of saw 24, it should be understood by the skilled person in this field that the structure of carriage member 80 could be modified to correspond to differently shaped hand held tools. Of course, depending upon modifications to carriage member 80, it might also be necessary to modify the structure of guide member 60. However, it is believed that such modifications would be within the normal ordinary skill of such persons.

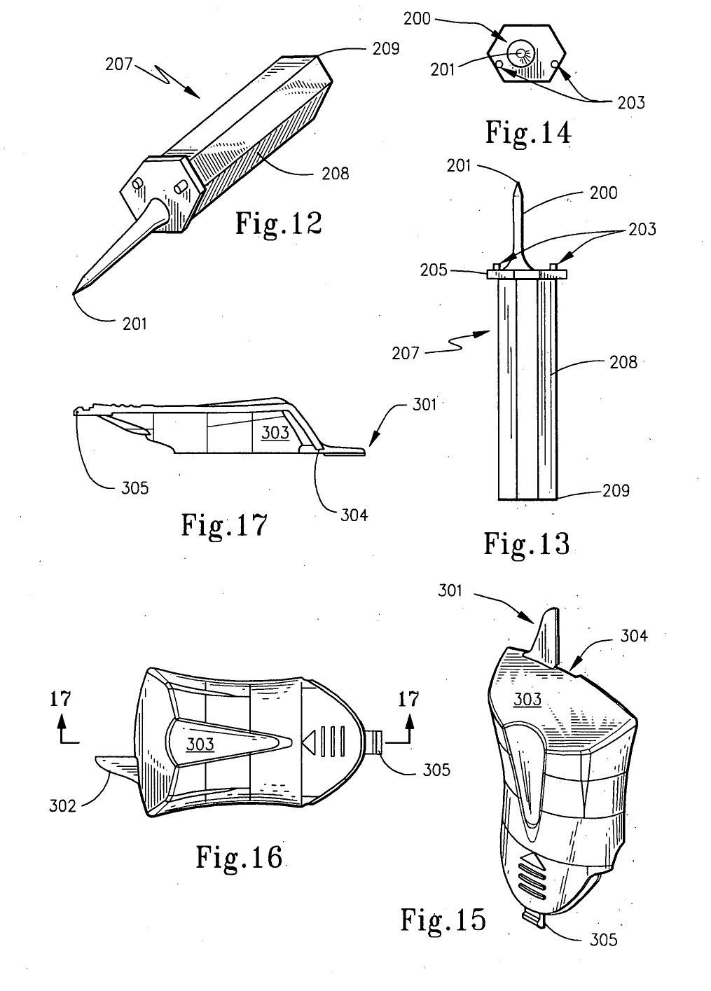

The poker tool 207 shown in FIGS. 12-14 is a hexagonal handled tool that inserts into the power drive handle for use as a mechanized poking tool. The poker tool 207 has the addition of two small “protrusions” 203 on the distal end of the flange 205 that goes around the handle 208. The function of these protrusions 203 will be discussed later. At the very distal end of the poker is a sharp point 201 at the end of a short shank or shaft 200 that is shaped similar to a golf tee. The shank axis is laterally off-center to the main hex-handle tool axis so that it can be more closely aligned with the wing 301.

The clear power guide cover as shown in FIGS. 15-17 is a clear plastic piece 303 that has several functions; it is removable for tool swapping, it is clear so that the tool being used can be seen, it completes the handle geometry, and it acts as a tool rest. The proximal end 305 of the cover snaps into place near the distal end of the power drive handle base. The cover has an wing or extension 301 at the left distal end. The extension is somewhat centered on the tool opening 304 which can best be seen in FIG. 17. The wing extension 301 is positioned this way to more closely align with the poker tip 201 and shank 200. The wing 301 is located on the left side of the tool so that it does not obstruct the view of either right or left handed use of the tool. The wing 301 has a particular shape 302 on the distal end that adds functionality to the extension, as described below.

By resting the rounded profile 302 on the surface to be poked (working surface), (i.e. the pumpkin shell or the pattern to transfer that is taped to the pumpkin), and changing the relative angle of the tool axis to the working surface the user can change the depth of penetration. For example, by placing the drive handle base with the wing 302 at a perpendicular angle to the surface to be poked, then the net extension of the poker tip 201 will be allowed to maximally penetrate the working surface. If, however, the angle between the tool axis and the working surface is decreased by resting a more proximal portion of the rounded extension area 302 on the working surface, the potential penetration depth of the poker tip is decreased. The advantage of this change of depth penetration is to allow the tool user to intuitively make adjustments for a smoother operation of the tool and to allow better access to all surfaces on an irregular surface such as the grooves or channels of a pumpkin's outer shell. By resting the wing 301 on the working surface, the cover 303 acts as a stabilizer, visual indicator of where the poker will penetrate the working surface, and, since it is made of clear material, it offers a fairly unobstructed view of the tool reciprocation.

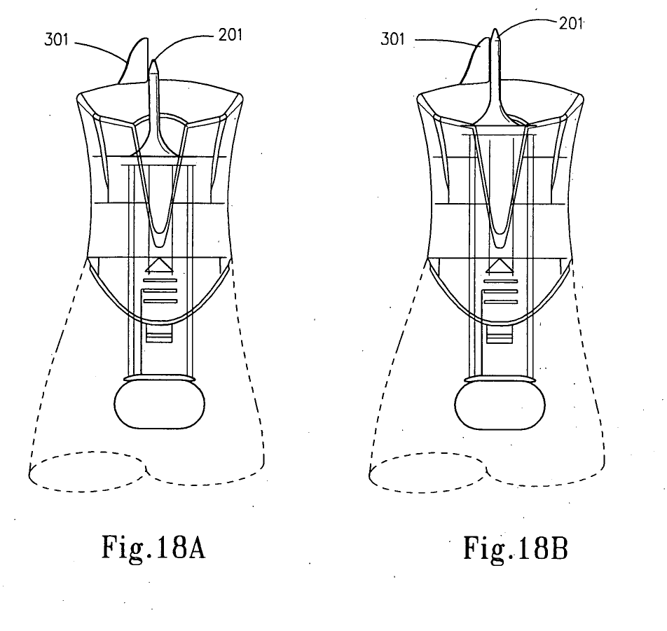

The relationship between the cover and the poker in the power saw base is shown in FIGS. 18A and 18B. The poker tip 201 extends distally beyond the wing 301 at the end of its reciprocating cycle and moves proximally along the tool axis. The wing 301 is the main contact point between the tool and the working surface. By limiting or controlling the net extension of the poker tip 201 beyond the wing 301, the user can effectively limit or control the amount of kickback in the tool caused by the poker tip 201 making contact with the working surface. Having the extension wing 301 resting on the working surfaces acts to dampen the kickback.

The power poker is placed inside the power drive handle base by placing the proximal end 209 into the tool cradle with the poker tip 201 end most distally located from the tool cradle housing. The tool cradle will normally accept the hexagonal tools in only two positions, which are supine and prone. Since the poker shank 200 is off-center from the main tool and handle axis, there is a correct way and incorrect way to orient and place the poker into the tool cradle. The two small protrusions 203 act to interfere with material on the tool cradle if the poker is placed incorrectly into the cradle, thus not allowing the poker to sit incorrectly in the tool housing. The shank 200 should be located nearest the wing 301 for optimal performance. Having the shank off-centered and the wing 301 be somewhat centered on the tool tip opening 304, allows for a closer physical and therefore visual association of the wing 301 and poker tip 201. This association makes it easier for the user to accurately transfer the pattern onto the working surface.

The power drive handle is held in either the left or the right hand similar to how one would hold a stylus for writing or drawing with the clear cover 303 located distally from the hand. The wing 301 is oriented below the poker shank 200 so that it can rest on the working surface without obstruction from the tool (i.e. Poker or Saw) in use. The tool is turned on so that the poker reciprocates along the main handle tool axis. The wing 301 rests on the working surface and the poker tip 201 is mechanically thrust into the soft working surface material. The user then traces the pattern to be transferred with the tip of the wing 301, adjusting the depth by changing the angle as necessary to allow penetration into the working surface. Since the extension tip and the poker tip 201 are aligned so closely, the user can easily and intuitively visually predict where the poker tip will penetrate the working surface, thus creating the mark (usually the penetration point) that is the result of transferring the intended design onto the working surface. Where necessary, the poker can be removed from the tool housing and manually used to poke the working surface without mechanical help. Once the pattern design is transferred, the pattern is removed from the working surface and carving can begin by following the “line” of marks created by the poker tip's 201 penetration.

Accordingly, the present invention has been described with some degree of particularity directed to the exemplary embodiments of the present invention. It should be appreciated, though, that modifications or changes may be made to the exemplary embodiments of the present invention without departing from the inventive concepts contained herein.

I claim:

1. A power drive handle for a handheld tool adapted for use in carving soft materials wherein said tool includes a tool handle and a tool element, comprising:
(A) a case including a forward nose having a tool element opening formed therein with said case having an interior;
(B) a drive motor disposed in the interior of said case;
(C) a carriage disposed in the interior of said case and mounted for reciprocal motion in a longitudinal direction, said carriage adapted to releasably mount the tool handle of said handheld tool such that the tool element thereof protrudes from said case through the tool element opening when in a mounted state;
(D) a drive train disposed in the interior of said case, said drive train coupling said drive motor and said carriage such that operation of said drive motor acts to reciprocate said carriage whereby said tool element is reciprocated when in the mounted state; and
(E) a wing extension projecting longitudinally forwardly of said nose adjacent to the tool element opening.

2. A power drive handle according to claim 1 said case includes a detachable access panel that is detachable so as to allow access to said carriage whereby the tool handle of a selected handheld tool may be mounted and demounted therein.

3. A power drive handle according to claim 2 wherein said access panel is transparent.

4. A power drive handle according to claim 2 wherein said wing extension is formed on said access panel.

5. A power drive handle according to claim 1 wherein said case includes a compartment adapted to receive a power supply for said drive motor.

6. A power drive handle according to claim 1 wherein said casing includes a forwardly located nose wherein the tool element opening is formed in said nose.

7. A power drive handle according to claim 1 wherein said carriage is trough-shaped in configuration so as to provide a bay adapted to receive the tool handle.

8. A power drive handle according to claim 6 wherein the tool handle of the handheld tool includes a flange, said carriage including a groove sized and adapted to receive the flange when the tool handle is received in the bay.

9. A power drive handle according to claim 6 including a trough-shaped guide member forming a longitudinally extending slideway sized and adapted to slideably receive said carriage member therein for reciprocal movement.

10. A power drive handle according to claim 1 wherein said drive motor includes an output pinion gear, said drive train including reduction gear mechanically coupled to said pinion gear and a geared crank mechanically coupled to reduction gear, and wherein said carriage is mechanically coupled to said geared crank.

11. A power drive handle according to claim 1 wherein said case includes a storage space adapted to receive a handheld tool.

12. A power drive handle according to claim 1 wherein said wing extension has a longitudinally extending linear first edge located adjacent to the tool element opening and an arcuate second edge so as to define a forwardly located rounded profile.

13. A handheld powered poker adapted for use in transferring patterns to be carved in soft materials, comprising:
(A) a power drive handle including
(1) case including a forward nose having a tool element opening formed therein with said case having an interior,
(2) a drive motor disposed in the interior of said case,
(3) a carriage disposed in the interior of said case and mounted for reciprocal motion in a longitudinal direction,
(4) a drive train disposed in the interior of said case, said drive train coupling said drive motor and said carriage such that operation of said drive motor acts to reciprocate said carriage between an advanced position and a retracted position whereby said tool element is reciprocated between an extended position and a retracted position, and
(5) a wing extension projecting longitudinally forwardly of said nose adjacent to the tool element opening; and
(B) a poker tool including a poker handle having a central longitudinal axis and a longitudinally and forwardly extending shaft terminating in a point, said tool handle sized adapted to be releasably mounted in said carriage in a mounted state such that said shaft protrudes from said case through the tool element opening.

14. A handheld powered poker according to claim 13 said case includes a detachable access panel that is detachable so as to allow access to said carriage whereby said poker tool may be mounted and demounted therein.

15. A handheld powered poker according to claim 14 wherein said access panel is transparent.

16. A handheld powered poker according to claim 14 wherein said wing extension is formed on said access panel.

17. A handheld powered poker according to claim 13 wherein said poker tool is configured such that it may only be mounted in a single orientation relative to said carriage.

18. A handheld powered poker according to claim 13 wherein said carriage is trough-shaped in configuration so as to provide a bay adapted to receive said poker handle.

19. A handheld powered poker according to claim 18 wherein said poker handle includes a flange located proximate to said shaft, said carriage including a groove sized and adapted to receive said flange when said poker handle is received in the bay.

20. A handheld powered poker according to claim 19 wherein said flange includes positioning structures operative to permit receipt of said flange in the groove in only a single orientation.

21. A handheld powered poker according to claim 13 wherein said shaft is oriented in a common plane with said wing extension when said poker tool is in the mounted state.

22. A handheld powered poker according to claim 21 wherein said shaft is laterally offset from the central longitudinal axis of said poker handle.

23. A power drive handle according to claim 13 including a trough-shaped guide member forming a longitudinally extending slideway sized and adapted to slideably receive said carriage member therein for reciprocal movement.

24. A power drive handle according to claim 13 wherein said wing extension has a longitudinally extending linear first edge located adjacent to the tool element opening and an arcuate second edge so as to define a forwardly located rounded profile.

25. A power drive handle according to claim 13 including a saw tool having a saw handle and a saw blade extending forwardly of said saw handle, said saw handle sized and adapted to be releasably mounted in said carriage in a mounted state such that said saw blade protrudes from said case through the tool element opening.

26. A handheld power tool poker adapted for use in transferring patterns to be carved in soft materials, comprising:
(A) a power drive handle including
(1) case including a forward nose having a tool element opening formed at a nose portion thereof with said case having an interior,
(2) a first a detachable access panel that is detachable so as to allow access to said carriage whereby the tool handle of a selected handheld tool may be mounted and demounted therein,
(3) a second detachable access panel that is detachable so as to allow access to said carriage whereby the tool handle of a selected handheld tool may be mounted and demounted therein, said second detachable access panel including a wing extension projecting longitudinally forwardly of said nose portion adjacent to the tool element opening,
(4) a drive motor disposed in the interior of said case,
(5) a carriage disposed in the interior of said case and mounted for reciprocal motion in a longitudinal direction,
(6) a drive train disposed in the interior of said case, said drive train coupling said drive motor and said carriage such that operation of said drive motor acts to reciprocate said carriage between an advanced position and a retracted position whereby said tool element is reciprocated between an extended position and a retracted position; and
(B) a poker tool including a poker handle having a central longitudinal axis and a longitudinally and forwardly extending shaft terminating in a point, said tool handle sized adapted to be releasably mounted in said carriage in a mounted state such that said shaft protrudes from said case through the tool element opening a wing extension projecting longitudinally forwardly of said nose adjacent to the tool element opening.
